(19) United States
(12) Patent Application Publication
(10) Pub. No.: US 2021/0273778 A1
(43) Pub. Date: Sep. 2, 2021

(54) METHOD FOR EXECUTING A FUNCTION, BY A MICROPROCESSOR, SECURED BY TIME DESYNCHRONISATION

(71) Applicant: COMMISSARIAT A L'ENERGIE ATOMIQUE ET AUX ENERGIES ALTERNATIVES, Paris (FR)

(72) Inventors: Nicolas BELLEVILLE, Grenoble (FR); Damien COUROUSSE, Grenoble (FR)

(73) Assignee: COMMISSARIAT A L'ENERGIE ATOMIQUE ET AUX ENERGIES ALTERNATIVES, Paris (FR)

(21) Appl. No.: 17/261,755

(22) PCT Filed: Jul. 2, 2019
(86) PCT No.: PCT/FR2019/051640

§ 371 Date: Jan. 20, 2021

(30) Foreign Application Priority Data
Jul. 23, 2018 (FR) 1856781

(51) Int. Cl. H04L 9/00

(52) U.S. Cl. CPC H04L 9/002; H04L 9/003; H04L 9/004; H04L 2209/08

(57) ABSTRACT

A method for executing a function secured by time synchronisation, comprising the random choice of a value of a delay from a group G2,k of n2,k possible values, the random choice being performed according to a probability law Sk, the values of the group G2,k fulfilling the following condition: wherein x0 to Xn2,k−1 are the n2,k values of the group G2,k, Sk[xI] is the probability of occurrence associated with the value Xi by the law Sk, SSk is the statistical distribution of the possible values of the accumulated delays already introduced between times tref and tsk, tsk is the time at which the microprocessor executes the first instruction of a sequence Seqk, tref is the reference time when the microprocessor executes a particular instruction, SSmaxk is the largest value of the statistical distribution SSk, and p is a real number greater than 1.3.

The invention relates to a method allowing a function secured by temporal desynchronization to be executed by a microprocessor, and to a data-storage medium and an electronic computer for implementing this method.

Temporal desynchronization is an approach employed in software or hardware countermeasures to make attempts at cryptanalysis of a function executed, for example, by a microprocessor of an on-board system more difficult. Below, this executed function is called a “secure function” because it is generally a function, such as, for example, an encryption or decryption function, that executes operations that are the primary target of attackers.

Cryptanalysis of a function in particular consists in studying the operation of this function in order to reveal secret information processed by this function, or to modify its operation. Attempts at cryptanalysis are conventionally called “attacks”.

Temporal desynchronization is, for example, an effective way of making side-channel attacks more difficult. Side-channel attacks encompass a wide variety of different possible attacks. For example, certain of these attacks consist in measuring a physical quantity correlated with the operations executed by the microprocessor when it is executing the secure function. This physical quantity may be the electrical power consumption of the microprocessor, the electromagnetic radiation from the microprocessor, the noise of the microprocessor, the execution time, inter alia. In the case where the physical quantity is the electrical power consumption of the microprocessor, this attack is known by the acronym DPA (“Differential Power Analysis”) or CPA (“Correlation Power Analysis”). These attacks aim to correlate an external event, such as the measurement of a physical quantity, with the time at which a particular instruction of the secure function is executed. Temporal-desynchronization techniques aim to make it more difficult to establish this correlation between external events and the execution of certain particular instructions.

Another known attack is, for example, the fault injection attack. This attack consists in causing a fault or a malfunction of the microprocessor at the particular time at which it is executing a critical instruction of the secure function. A critical instruction is, for example, a conditional branch instruction in order to cause an unexpected operation of this secure function. In the context of this type of attacks, temporal desynchronization increases how difficult it is for an attacker to target with fault injection the time at which a particular instruction of the secure function is executed.

These attacks have in common that it is necessary to correlate an external event, such as a measurement of electrical power consumption or the injection of a fault, with the time at which a particular instruction of the secure function is executed. Temporal-desynchronization techniques aim to make it more difficult to establish this correlation between external events and the execution of certain particular instructions. To this end, it has already been proposed to introduce a random time lag before the execution of each instruction of the secure function. Thus, known methods allowing a function to be executed by a microprocessor comprise:
the execution, by the microprocessor, of the instructions of the function one after another, and in parallel
the execution of a phase of temporal desynchronization, this phase of ordinary temporal desynchronization comprising, before the execution by the microprocessor of each instruction Iₘ of a group of instructions of the function, carrying out the following steps:
   1) making a random choice of a value of a first delay from a group G_{1,m} of n_{1,m} possible values of this first delay, where n_{1,m} is an integer higher than or equal to two, each of the n_{1,m} possible values being an integer multiple of an elementary duration dₑ, this random choice being made according to a first probability law Pₘ that associates a probability of occurrence with each of the possible values of the group G_{1,m}, then
   2) introducing a first time lag equal to the first delay before the execution of this instruction so that, with respect to the time at which the execution of the function begins, the time at which the execution of this instruction begins varies randomly on each execution of the function.

For example, such a method is disclosed in the following articles:
J. S. Coron et al.: “Analysis and improvement of the random delay countermeasure of CHES 2009”, lecture note in computer science, volume 6225 LNCS, pages 95-109, 2010. Below, this article will be referred to as “Coron2010”, and
Olivier Benoit et al.: “Efficient Use of Random Delays”, Jun. 14, 2006, downloadable from the following internet address: eprint.iacr.org/2006/272.ps.

By virtue of these known methods, the time at which a particular instruction of a secure function is executed varies randomly from one execution of this secure function to another.

The problem with the known methods is that the instructions of the secure function that are located, for example, at the start of this function are less well protected than the following instructions and are therefore more vulnerable to side-channel attacks, because the inserted time delay accumulates over the course of the instructions executed. Instructions that are located at the start of the secure function are those that are executed first. This will be explained using the following simplified example in which, whatever the index m:
n_{1,m}=2,
dₑ=1,
the two values contained in the group G_{1,m} are 0 and 1,
the probabilities Pₘ[0] and Pₘ[dₑ] of occurrence of the values 0 and dₑ, respectively, are both equal to 0.5, and
a first time lag is introduced before the execution of each instruction of the secure function.

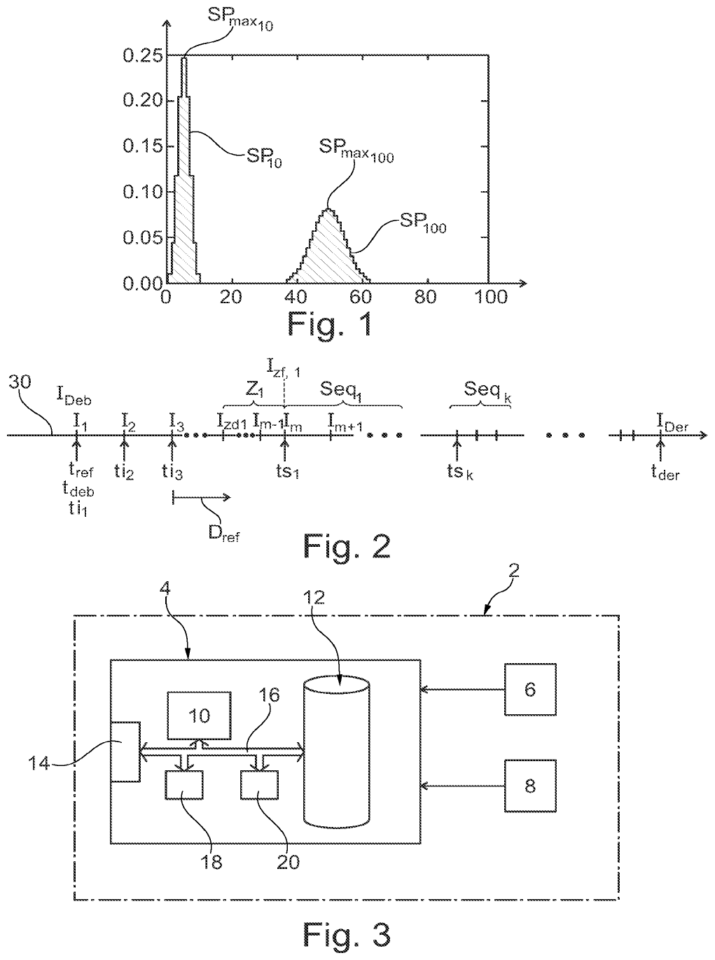

FIG. 1 shows the statistical distribution SP₁₀ of the sum of the first time lags after the introduction of the first ten time lags. This statistical distribution associates with each of the possible values of the sum of the first ten time lags its probability of occurrence. The possible values of the sums of the time lags are represented on the x-axis and the probability of occurrence is represented on the y-axis. The highest value, also called the “maximum”, of the statistical distribution SP₁₀ is denoted by SPmax₁₀. After insertion of the tenth first time lag, the maximum SPmax₁₀ is about equal to 0.25. Thus, the tenth instruction of the secure function is executed at the same time one time in four.

FIG. 1 shows, on the same graph, a statistical distribution SP₁₀₀ of the sum of the first time lags after the introduction of 100 first time lags. This time, the highest value SPmax₁₀₀ of the distribution SP₁₀₀ is 0.08. This means that the hundredth instruction of the secure function is executed at the same time approximately one time in twelve. Therefore, the temporal correlation between an external event and the execution of the hundredth instruction is more difficult to establish than the temporal correlation between an external event and the execution of the tenth instruction. In other words, the hundredth instruction is better protected against side-channel attacks than the tenth instruction.

At the present time, the difficulty of a side-channel attack is considered to be inversely proportional to the height of the maximum SPmaxₘ of the statistical distribution SPₘ, where the index m is the order number of the instruction counted, for example, from the first I_{Deb} instruction of the secure function. On this subject, the reader may consult the article Coron2010.

To remedy this problem, it has already been proposed to modify each law Pₘ so that the statistical distributions SPₘ exhibit lower maximums SPmaxₘ including for low values of the index m. For example, this is what is proposed in the article Coron2010 or the article by Olivier Benoit cited above.

In particular, in the article by Olivier Benoit, the proposed law Pₘ is constructed so that the statistical distribution SPₘ has the largest possible standard deviation and therefore so that it is as flat as possible. The proposed law Pₘ is non-uniform. As indicated in this article, because the law Pₘ is non-uniform, in the particular case where a single time lag, drawn using this law Pₘ, is introduced before the sequence of instructions to be protected, the robustness of this sequence of instructions to a side-channel attack is decreased. To mitigate this drawback, it is proposed, in this particular case, to draw this single time lag with a uniform law and to use the law Pₘ for all the other time lags introduced elsewhere. In the article by Olivier Benoit, the group of possible values from which the values of the introduced time lags are drawn is the set [1; 255]. It is underlined that this set [1; 255] combined with the law Pₘ does not meet condition (1) described later on in this patent application. Specifically, condition (1) depends on a statistical distribution SSₖ of the sum of the time lags already introduced before the execution of the instruction to be protected. However, these already-introduced time lags are all drawn using the law Pₘ except possibly one time lag that is drawn using the uniform law. Thus, to verify whether condition (1) is met or not by the set [1; 255], it is necessary to take into account the distribution SSₖ and therefore the statistical distribution of the sum of the time lags already introduced using the law Pₘ. Simulations carried out by the inventors have shown that, in the case of the embodiment presented as preferred in the article by Olivier Benoit (i.e. for the following values of the parameters of the law Pₘ: a=32, b=16, k=0.92), condition (1) is not met. Other simulations carried out for the numerical values of the parameters a, b and k given in tables 1 and 2 of the article by Oliver Benoit have shown that condition (1) is not met by any of the numerical examples disclosed in this article. This is due to the fact that the law Pₘ was constructed to obtain the flattest possible statistical distribution of the sum of the introduced time lags.

Moreover, in practice, it is sometimes not possible or not desirable to modify the laws Pₘ.

The invention therefore aims to provide a method for executing a function secured by temporal desynchronization that is more robust against attacks and without it being necessary to modify the laws Pₘ already employed to achieve this. One subject thereof is therefore such an executing method as claimed in claim 1.

The embodiments of this method may comprise one or more of the features of the dependent claims.

Another subject of the invention is a data-storage medium that is readable by an electronic computer, wherein this data-storage medium comprises instructions for executing the method that is one subject of the present patent application, when these instructions are executed by the electronic computer.

Another subject of the invention is an electronic computer for implementing the claimed method.

The invention will be better understood on reading the following description, which is given merely by way of non-limiting example, and with reference to the drawings, in which:

FIG. 1 is a graph showing statistical distributions of the sum of the first delays,

FIG. 2 is a schematic illustration, along an axis, of the various times at which instructions of a secure function are executed,

FIG. 3 is a schematic illustration of the structure of a computing system capable of executing a secure function;

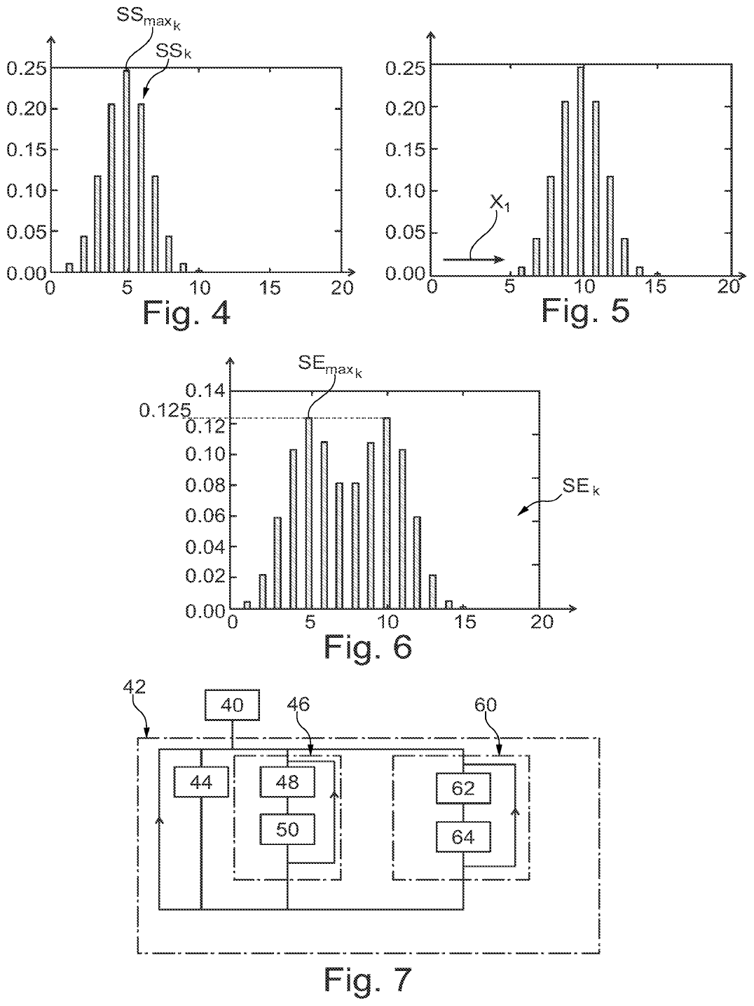

FIGS. 4 to 6 are graphs showing various statistical distributions of delay sums useful for understanding the operating principle of the temporal desynchronization implemented by the system of FIG. 3;

FIG. 7 is a flowchart of a method for executing a secure function, which method is implemented by the system of FIG. 3.

### SECTION I: TERMINOLOGIES AND NOTATIONS

In these figures, the same reference numbers have been used to denote elements that are the same. In the remainder of this description, features and functions that are well known to a person skilled in the art are not described in detail.

FIG. 2 is used to introduce various notations that are then used in this text. FIG. 2 shows a time axis 30 on which each graduation corresponds to a time at which an instruction Iₘ of a secure function is executed. The index “m” is the order number of the instruction with respect to the other instructions of the secure function. This order number m is assigned by taking as its origin a reference instruction I₁ of the secure function and proceeding in a reference direction D_{ref}. Thus, starting from the instruction I₁ and proceeding in the direction D_{ref}, the first instruction is the instruction I₁, the second instruction encountered is the instruction I₂ and so on until the last synchronized-function instruction encountered proceeding in the direction D_{ref}. It will be noted that the direction D_{ref} may correspond to the direction in which the instructions Iₘ are temporally executed one after another by an electronic computer or to the inverse direction. It will also be noted that the order in which the instructions Iₘ are executed may depend on the values of the variables processed by the secure function. Thus, the value of the index m associated with an executed instruction may vary as a function of the values of the processed variables. Below, to simplify the explanations and because this corresponds to the worst case, the values of the variables processed on each execution of the secure function are considered to remain constant so that the value of the index m associated with a given instruction is always the same. In the contrary case where the values of the processed variables change and cause a modification of the order of execution of the instructions, this further increases the temporal desynchronization.

Below, unless otherwise indicated, terms such as “preceding instruction”, “following instruction”, “before”, and “after”, are defined with respect to the direction D_{ref}. Thus, the instruction preceding the instruction Iₘ is the instruction Iₘ₋₁.

The terms “first instruction of the secure function” and “last instruction of the secure function” designate the first and last instruction of the secure function in the order in which these instructions are executed by an electronic computer, respectively. These first and last instructions are denoted I_{Deb} and I_{Der}, respectively. These instructions I_{Deb} and I_{Der} are independent of the direction D_{ref}.

The instruction I₁ is typically an instruction that corresponds to a time that could be chosen as a synchronization time by an attacker wishing to implement a side-channel attack. It is therefore a particular instruction of the secure function, the execution of which is easy to identify. Typically, it is the instruction I_{Deb} or the instruction I_{Der} of the secure function.

When the instruction I₁ is the first instruction I_{Deb} of the secure function, then the direction D_{ref} points from the instruction I_{Deb} to the instruction I_{Der}. In contrast, when the instruction I₁ is the last instruction I_{Der} of the secure function, the direction D_{ref} points from the instruction I_{Der} to the instruction I_{Deb}.

FIG. 2 shows the particular case where the instruction I₁ is equal to the instruction I_{Deb}. To simplify the description, the embodiments described with reference to the figures are described in this particular case.

The time taken by the electronic computer to execute the instruction Iₘ is denoted tiₘ. In the particular case of the instructions I₁, I_{Deb} and I_{Der}, these execution times are also denoted t_{ref}, t_{deb} and t_{der}, respectively.

Lastly, the secure function comprises one or more sequences Seqₖ of instructions. A sequence Seqₖ is a group of one or more instructions Iₘ that are systematically executed one after another. The sequences Seqₖ are separate from one another. Thus, an instruction Iₘ that belongs to any sequence Seqₖ cannot also belong to another sequence of instructions.

Similarly to what was explained with respect to the index m, the index k is the order number of the sequence Seqₖ with respect to the other sequences of instructions of the secure function. This order number is assigned by taking instruction I₁ as the origin and proceeding in the direction D_{ref}. Thus, starting from the instruction I₁ and proceeding in the direction D_{ref}, the first sequence of instructions encountered is the sequence Seq₁, the second sequence of instructions encountered is the sequence Seq₂ and so on.

The terms “first instruction of the sequence Seqₖ” and “last instruction of the sequence Seqₖ” designate the first and the last instruction of the sequence Seqₖ in the direction D_{ref}, respectively.

The time of execution of the first instruction of the sequence Seqₖ is denoted tsₖ.

Here, each sequence Seqₖ is associated with a respective zone Zₖ of introduction of a second time lag. The zone Zₖ comprises one or more instructions Iₘ. It begins with an instruction denoted I_{Zd,k} and ends with an instruction denoted I_{Zf,k}. The zone Zₖ systematically precedes, in the direction D_{ref}, the sequence Seqₖ. Thus, the instruction I_{Zd,k} is systematically located before, in the direction D_{ref}, the first instruction of the sequence Seqₖ. The instruction I_{Zf,k} is located after the instruction I_{Zd,k} in the direction D_{ref}. The instruction I_{Zf,k} is also located before, in the direction D_{ref}, or coincides with the first instruction of the sequence Seqₖ. In FIG. 2, only the zone Z₁ associated with the sequence Seq₁ has been shown, in the particular case where the instruction I_{Zf,1} is coincident with the first instruction of the sequence Seq₁.

### SECTION II: EXEMPLARY EMBODIMENTS

FIG. 3 shows a computing system 2 notably comprising an electronic computer 4 capable of executing a secure function. This system 2 also comprises:
a clock 6 that sets the rate of operation of the components of the computer 4, and
a power supply 8 that supplies the power required by the computer 4 to operate.

The secure function is typically a function that manipulates and/or processes secret information during its execution. For example, the secure function is an encryption or decryption function. In the case of encryption or decryption functions, the secret information often corresponds to an encryption or decryption key. For example, here, the secure function is an AES (“Advanced Encryption Standard”) encryption function. The secure function comprises a succession of instructions that codes the operations carried out by the computer 4 when it executes this secure function.

Many different architectures are possible for the computer 4. Here, by way of illustration, the computer 4 comprises:
a microprocessor 10 capable of executing the instructions of the secure function,
a memory 12 in which the instructions of the secure function to be executed are stored,
an input/output interface 14 allowing the computer 4 to exchange information with other electronic components of the system 2 such as, for example, a human-machine interface or a wireless transceiver, inter alia, and
a bus 16 that allows the various elements of the computer 4 to exchange data with one another.

To simplify FIG. 1, the other components of the computer 4 have not been shown.

The computer 4 is capable of producing temporal variability on each execution of the secure function. To this end, it comprises an ordinary-temporal-desynchronization module 18 and a reinforced-temporal-desynchronization module 20.

The module 18 is for example a conventional temporal-desynchronization module. For example, it is here a hardware module capable of introducing a random time lag before the execution of each instruction Iₘ of the secure function. Below, the random time lags introduced by the module 18 are called “first time lags”. The first time lag introduced before the instruction Iₘ is introduced between the times tiₘ₋₁ and tiₘ. For example, the first time lags are introduced by varying the frequency of the clock 6. On this subject, the reader may refer to the following article: T. Guneysu et al.: “Generic side-channel countermeasures for reconfigurable devices,” Cryptographic Hardware and Embedded Systems CHES 2011, Springer Berlin Heidelberg, 2011, pp. 33-48.

To do this, before the execution of each instruction Iₘ, the module 18 randomly chooses a value of a first delay from a group G_{1,m} of n_{1,m} possible values of this first delay. The number n_{1,m} is an integer higher than or equal to two. The values of the group G_{1,m} are typically integer multiples of an elementary duration dₑ. In the particular case described here, the various values of the group G_{1,m} are denoted j.dₑ where:
j is an integer between 0 and n_{1,m}−1, and
the symbol “.” designates, throughout this text, the operation of multiplication.

The module 18 chooses each new value of the first delay from the group G_{1,m} by carrying out a random draw that respects a probability law Pₘ. The law Pₘ associates with each value of the group G_{1,m} a probability of occurrence. Here, the law Pₘ and the group G_{1,m} are for example the same whatever the values of the index m.

The module 20 reinforces the temporal desynchronization of the sequences Seqₖ of instructions. To do this, for example, independently of the operation of the module 18, the module 20 is capable of introducing, before each time tsₖ at which the execution of the sequence Seqₖ begins, an additional time lag called the “second time lag” below. Generally, this second time lag is introduced between the times tsₖ₋₁ and tsₖ. Here, this second time lag is introduced in the zone Zₖ located between the last instruction of the sequence Segₖ₋₁ and the first instruction of the sequence Seqₖ. Here, the instruction I_{Zf,k} is chosen to be equal to the first instruction Iₘ of the sequence Seqₖ. This zone Zₖ immediately precedes and is therefore contiguous with the sequence Seqₖ.

In the case of a software implementation of the module 20, the instruction I_{Zd,k} is for example an instruction that calls a routine RI2d that triggers the introduction of the second time lag before the execution of the instruction I_{Zf,k}. In this case, typically, the instruction I_{Zf,k} is the instruction located at the return address of the routine RI2d. The routine RI2d is executed by the microprocessor 10 before the execution of the first instruction of the sequence Seqₖ begins.

To introduce the second time lag, the module 20 randomly chooses a value of a second delay from a group G_{2,k} of n_{2,k} different values. The number n_{2,k} is an integer number higher than or equal to two. Below, the values contained in the group G_{2,k} are denoted x₀, x₁, . . . , xₗ, . . . , x_{n2,k-1}. Typically, each value xₗ is an integer multiple of the duration dₑ. To make this random choice, the module 20 uses a probability law Sₖ that associates a probability of occurrence Sₖ[xₗ] with each value xₗ of the group G_{2,k}. The sum of all these probabilities of occurrence Sₖ[xₗ] is equal to one. Next, a second time lag, the duration of which is equal to the second delay xₗ, is introduced between the times t_{Zd,k} and t_{Zf,k} at which the instructions I_{Zd,k} and I_{Zf,k} are executed, respectively.

By way of illustration, the routine RI2d comprises instructions that, when they are executed by the microprocessor 10:
randomly draw, using the law Sₖ, an integer number q from a set of n_{2,k} different integer numbers, then
execute q instructions that are unnecessary for the processing performed by the secure function. In this embodiment, the random draw of the integer q corresponds to the random selection of a value from the group G_{2,k}. In this case, the values of the group G_{2,k} each correspond to a respective number of executions of unnecessary instructions. More precisely, if the time required by the microprocessor 10 to execute an unnecessary instruction is denoted dₖ, then each value xₗ is equal to q.dₖ, where dₖ is for example itself an integer multiple of the duration dₑ.

Here, the module 20 is associated with a memory in which is stored for each sequence Seqₖ:
the various values xₗ of the group G_{2,k}, and
the probabilities of occurrence Sₖ[xₗ] associated with each of these values of the group G_{2,k}.

For example, by way of illustration, this information is stored in the memory 12.

Preferably, the law Sₖ is practically equiprobable, i.e., whatever the value xₗ, the probability Sₖ[xₗ] is comprised between 0.9/n_{2,k} and 1.1/n_{2,k}. In this embodiment, each law Sₖ is equiprobable, i.e. each probability Sₖ[xₗ] is equal to 1/n_{2,k}.

To increase the temporal desynchronization of the sequence Seqₖ, the values xₗ of the group G_{2,k} stored beforehand in the memory 12 meet the following condition (1):

$$∀ j ∈ lN , {\sum }_{l = 0}^{{n}_{2 , k} - 1} {S}_{k} [ {x}_{l} ] {SS}_{k} ( j . {d}_{e} + {x}_{l} ) < \frac{{SSmax}_{k}}{P} \qquad ( 1 )$$

where:
SSₖ is the statistical distribution of the possible values of the sum of the time lags that have already been introduced between the times t_{ref} and tsₖ,
SSmaxₖ is the highest value, also called the “maximum”, of the statistical distribution SSₖ,
p is a real number higher than or equal to 1.05 and, preferably, higher than or equal to 1.3 or 1.5 or 1.8 or 2.

The sum of the time lags already introduced between the times t_{ref} and tsₖ notably comprises:
the sum of the first time lags introduced by the module 18 between the times t_{ref} and tsₖ,
the sum of the second time lags introduced by the module 20 between the times t_{ref} and tsₖ₋₁.

It will be noted that this sum may also take into account any time lag other than those introduced by modules 18 and 20. In contrast, this sum does not take into account the second time lag selected using the law Sₖ.

The number p is a number chosen during the design of the law Sₖ. The higher this number p, the lower the maximum SEmaxₖ and therefore the greater the robustness of the sequence Seqₖ to side-channel attacks. The maximum of a statistical distribution SEₖ is here denoted SEmaxₖ. The statistical distribution SEₖ is the statistical distribution of the sum of all the time lags introduced between the times t_{ref} and tsₖ. The statistical distribution SEₖ is therefore identical to the statistical distribution SSₖ except that it in addition takes into account the second time lag selected using the law Sₖ.

The reason why meeting condition (1) allows the maximum SEmaxₖ to be decreased will now be explained with reference to FIGS. 4 to 6. The axes of the graphs of FIGS. 4 to 6 are the same as those described with respect to FIG. 1.

These explanations are given in the particular case where n_{2,k} is equal to two, so that the two values of the group G_{2,k} are x₀ and x₁. In addition, here, the value x₀ is zero and the value x₁ is an integer multiple of the duration dₑ. For example, the value x₁ is equal to 5dₑ. The law Sₖ is equiprobable and therefore the probabilities of occurrence of the values x₀ and x₁ are both equal to 0.5.

FIG. 4 shows an example of a distribution SSₖ for which the highest value SSmaxₖ is about 0.25. The distribution SSₖ is identical to the distribution SEₖ that would be obtained if the value of the second time lag introduced before the sequence Seqₖ were systematically chosen to be equal to x₀ on each execution of the secure function.

The graph of FIG. 5 shows the statistical distribution SEₖ that would be obtained if the value of the second time lag introduced before the sequence Seqₖ were systematically chosen to be equal to x₁ on each execution of the secure function. The distribution of FIG. 5 is therefore identical to that of FIG. 4 except that it is shifted to the right by the value x₁.

The graph of FIG. 6 shows the statistical distribution SEₖ that is obtained when there is one chance in two that the value of the second time lag introduced is x₀ or x₁. It will be noted that the distribution SEₖ is the weighted sum of the statistical distributions shown in FIGS. 4 and 5, where the weighting coefficients of each of these statistical distributions of FIGS. 4 and 5 are equal to the probabilities of occurrence Sₖ[x₀] and Sₖ[x₁], respectively. In the particular case described here, the weighting coefficient of the statistical distributions of FIGS. 4 and 5 is therefore 0.5. In other words, with each possible value j.dₑ of the sum of the introduced time lags, the statistical distribution SEₖ associates the following probability of occurrence: SEₖ(j.dₑ)=Sₖ[x₀].SSₖ(j.dₑ+x₀)+Sₖ[x₁].SSₖ(j.dₑ+x₁).

Therefore, if condition (1) is met, whatever the value of the index j, the probability of occurrence SEₖ(j.dₑ) is lower than SSmaxₖ/p. The maximum SEmaxₖ is therefore necessarily lower than the maximum SSmaxₖ. Thus, the introduction of the second time lag decreases the value of the maximum SEmaxₖ with respect to an embodiment in which this second time lag would never be introduced before the time tsₖ. Therefore, provided that the values xₗ of the group G_{2,k} meet condition (1), the temporal desynchronization of the sequence Seqₖ is improved by a configurable factor related to the factor 1/p. In the particular case of the above explanations, the maximum SEmaxₖ is two times lower than the maximum SSmaxₖ, despite introducing a second time lag that is only equal to x₁/2 on average.

Condition (1) is expressed in the general case where:
the number n_{2,k} may be higher than or equal to two,
the values xₗ are not necessarily integer multiples of the delay dₖ, and
the law Sₖ is not necessarily equiprobable.

It is possible to determine a high number of sets of values xₗ that meet condition (1). However, among this high number of possible sets of xₗ values, certain are more advantageous than others. These sets of values x₁ that are more advantageous than others meet additional conditions. For example, in this embodiment, the values of the group G_{2,k} in addition meet the following condition, condition (2):

$$∀ j ∈ lN , {\sum }_{l = 0}^{{n}_{2 , k} - 1} {S}_{k} [ {x}_{l} ] {SP}_{k} ( j . {d}_{e} + {x}_{l} ) < \frac{{SPmax}_{k}}{P} \qquad ( 2 )$$

where:
SPₖ is the statistical distribution of the possible values of the sums of the first time lags introduced between the times t_{ref} and tsₖ, and
SPmaxₖ is the maximum of the statistical distribution SPₖ.

Thus, contrary to the statistical distribution SSₖ, the distribution SPₖ takes into account only the introduced first time lags. Therefore, notably, it does not take into account any second time lags introduced before the time tsₖ₋₁.

Currently, it is believed that if the values of the group G_{2,k} meet condition (2) then they also necessarily meet condition (1). The statistical distribution SPₖ is easier to determine than the distribution SSₖ. For example, the distribution SPₖ may be measured experimentally. To do this, in an initialization phase, the secure function is executed multiple times by a computer identical to computer 4 except that it is devoid of a module 20. During each of these executions, the time at which the execution of the sequence Seqₖ begins is recorded. On the basis of these recordings, the statistical distribution SPₖ is then constructed. It will be noted that the advantage of measuring the statistical distribution SPₖ is that this may be done without knowing the various laws Pₘ used by the module 18.

Alternatively, if, conversely, the various laws Pₘ used by the module 18 are known, then it is also possible to construct the statistical distribution SPₖ by computation, this being simple and rapid. Once the statistical distribution SPₖ has been constructed, its maximum SPmaxₖ is also known.

Moreover, in order not to slow down the execution of the secure function too much, it is desirable for the weighted average of the introduced second time lags to be as low as possible. To this end, it is required here that x₀=0. In addition, regardless of the index l higher than or equal to 1, it is also required that the values xₗ be comprised between 0.9.l.i.dₑ and 1.1.l.i.dₑ, where the number i is the lowest integer for which at least one of the following conditions (3) or (3′) is met:

$$\begin{matrix}∀ j ∈ lN , {\sum }_{l = 0}^{{n}_{2 , k} - 1} {S}_{k} [ l . i . {d}_{e} ] . {SS}_{k} ( j . {d}_{e} + l . i . {d}_{e} ) < \frac{{SSmax}_{k}}{P} \\ or & ( 3 ) \\ ∀ j ∈ lN , {\sum }_{l = 0}^{{n}_{2 , k} - 1} {S}_{k} [ l . i . {d}_{e} ] . {SP}_{k} ( j . {d}_{e} + l . i . {d}_{e} ) < \frac{{SPmax}_{k}}{P} & ( {3}^{′} )\end{matrix}$$

Condition (3′) is used if only the distribution SPₖ has been determined. Otherwise, preferably, condition (3) is used. Any set of values xₗ that meets condition (3) or (3′) also in addition meets condition (1). The sets of values xₗ that meet condition (3′) also in addition meet condition (2).

Finally, in this embodiment, it is in addition required that the group G_{2,k} be the same for T different sequences Seqₖ, where T is an integer higher than or equal to two. For example, the T sequences Seqₖ are the T successive sequences Seqₖ to Seq_{k+T-1}. To achieve this, the same set of values xₗ must meet conditions (3) or (3′) for k, k+1 up to k+(T−1). In other words, in this embodiment, regardless of the index l higher than or equal to 1, it is also required that the values xₗ be comprised between 0.9.l.i.dₑ and 1.1.l.i.dₑ, where the number i is the lowest integer for which at least one of the following condition (4) or (4′) is met:

$$\begin{matrix}∀ t ∈ [ k ; k + T - 1 ] , ∀ j ∈ lN , {\sum }_{l = 0}^{{n}_{2 , k} - 1} {S}_{k} [ l . i . {d}_{e} ] . {SS}_{k} ( j . {d}_{e} + l . i . {d}_{e} ) < \frac{{SSmax}_{k}}{P} \\ or & ( 4 ) \\ ∀ t ∈ [ k ; k + T - 1 ] , ∀ j ∈ lN , {\sum }_{l = 0}^{{n}_{2 , k} - 1} {S}_{t} [ l . i . {d}_{e} ] . {SP}_{k} ( j . {d}_{e} + l . i . {d}_{e} ) < \frac{{SPmax}_{t}}{P} & ( {4}^{′} )\end{matrix}$$

The operation of the system 2 will now be described with reference to FIG. 7.

The method begins with an initialization phase 40. This phase 40 begins with the identification of the sequences Seqₖ of instructions of the secure function that must be subjected to reinforced temporal desynchronization. There are many different ways of identifying these sequences. However, below, certain guidelines are given that allow the implementation of the method described here to be optimized. For example, for each possible sequence Seqₖ, a safety threshold S_{1,k}, below which the maximum SEmaxₖ must lie, is set. By way of illustration, here, this threshold S_{1,k} is the same for all the sequences Seqₖ. Typically, the threshold S_{1,k} is chosen to be lower than 0.2 or 0.1 and, preferably, lower than 0.08 or 0.05 or 0.01.

As explained above, the larger the summed amount of introduced first time lags, the more the value of the maximum SPmaxₘ decreases. There is therefore an index a+1, corresponding to an instruction Iₐ₊₁, from which the maximum SPmaxₘ is lower than the threshold S_{1,k}, without it being necessary to introduce second time lags. In other words, the instruction Iₐ is the last instruction for which the following condition is met: SPmaxₐ>S_{1,k}. It is therefore unnecessary to introduce second time lags after the execution of instruction Iₐ. The introduction of second time lags after the execution of the instruction Iₐ unnecessarily delays the execution of the secure function. Here, during phase 40, the instruction Iₐ is identified. To do this, for example, the distribution SPₘ of the sum of the first time lags between the time t_{ref} and the time tiₘ is determined by increasing the index m to the index a+1. The statistical distribution SPₘ is determined by measurement or by computation if the laws Pₘ are known. The instruction I_{f} of the secure function from which the introduction of second time lags must be inhibited is then chosen to lie between the instruction Iₐ and the instruction I_{b}. Therefore, the introduction of second time lags ceases well before the time t_{der} and even despite the fact that the introduction of first time lags continues after the execution of the instruction I_{f}, until the time t_{der}, for example. In order not to unnecessarily delay the execution of the secure function, the index b is here chosen to lie between a and a+100.

Generally, the first instructions of the secure function do not process secret information. There is therefore often an index d below which the introduction of the second time lag is also unnecessary. The sequences Seqₖ are therefore here located between the instructions I_{d} and I_{f}. Between these instructions I_{d} and I_{f}, certain sequences of instructions may be more critical than others. Thus, advantageously, each sequence Seqₖ corresponds to one of these more critical sequences of instructions. In this case, the sequences Seqₖ of instructions are separated from one another by less critical instructions of the secure function. The times of execution of these less critical instructions are desynchronized only by the introduction of first delays.

Lastly, each identified sequence Seqₖ is associated with one zone Zₖ. To do this, the instruction I_{Zd,k} is introduced in the code of the secure function between the last instruction of the sequence Seqₖ₋₁ and the first instruction of the sequence Seqₖ. Here, the instruction I_{Zd,k} is a call to the routine RI2d. In this case, the instruction I_{Zf,k} is the instruction located at the return address of this routine RI2d.

Also in phase 40, for each sequence Seqₖ, a law Sₖ is constructed so that following the introduction of the second time lag, the maximum SEmaxₖ is lower than the threshold S_{1,k}. To achieve this, the various statistical distributions SSₖ or SPₖ associated with each sequence Seqₖ are determined either from measurements or by computation if the laws Pₘ are known and the distribution is computable. Below, the particular case where it is the statistical distributions SPₖ that have been determined is considered. However, everything that is described in this particular case also applies to the case where it is the distributions SSₖ that are determined, the expression “SPₖ” simply needing to be replaced by the expression “SSₖ”.

When the statistical distribution SPₖ has been determined, the maximum SPmaxₖ is also known. The number p such that SPmaxₖ/p=S_{1,k} is then determined.

Next, the number n_{2,k} is set equal to or higher than the ceiling of the number p. The ceiling of a number is the lowest integer higher than or equal to that number.

The probability of occurrence Sₖ[xₗ] associated with each of the values xₗ of the group G_{2,k} is also chosen. Here, the law Sₖ is equiprobable, i.e. the law Sₖ is a discrete uniform law. In this case, the probability of occurrence Sₖ[xₗ] of each value xₗ is therefore equal to 1/n_{2,k}.

Lastly, for each set of T successive sequences Seqₖ to Seq_{k+T-1}, the values xₗ that meet condition (4′) are determined and stored in the memory 12. Thus, at the end of phase 40, for each sequence Seqₖ:
the code of the secure function comprises an instruction I_{Zd,k} that triggers the introduction of the second time lag,
the memory 12 comprises a group G_{2,k} of n_{2,k} values associated with this sequence Seqₖ, and
the memory 12 comprises a probability law Sₖ associated with this sequence Seqₖ.

Once the initialization phase 40 has ended, the system 2 may then proceed with a phase 42 of executing the secure function.

In the phase 42, and more precisely in step 44, the microprocessor 10 executes one after another the instructions Iₘ of the secure function.

In parallel, the module 18 executes, for example continuously, a phase 46 of ordinary temporal desynchronization. In this embodiment, phase 46 comprises, before the execution of each instruction Iₘ, the execution of the following operations 48 and 50.

In operation 48, the module 18 randomly chooses, according to the law Pₘ, a value of a first delay from the group G_{1,m}.

Next, in operation 50, the module 18 introduces a first time lag of duration equal to this first delay before the execution of the instruction Iₘ by the microprocessor 10. This first time lag is introduced between the times tiₘ₋₁ and tiₘ. The introduction of this first time lag therefore results in a shift of the time tiₘ with respect to the time tiₘ₋₁.

In parallel with step 44 and phase 46, module 20 executes a phase 60 of reinforced temporal desynchronization. The execution of phase 60 is here triggered only in response to each loading or execution of an instruction I_{Zd,k}. As explained above, in this embodiment, the instruction I_{Zd,k} is a call to the routine RI2d. The execution of phase 60 is then systematically interrupted in response to the instruction I_{Zf,k} being loaded or executed. When phase 60 is executed, the module 20 carries out the following operations.

In an operation 62, the module 20 randomly chooses a value of the second delay from the group G_{2,k}, this choice being made according to the law Sₖ.

Next, in an operation 64, the module 20 introduces a second time lag of duration equal to the second delay, chosen in operation 62, before the instruction I_{Zf,k} is loaded or executed, i.e. here before the instruction located at the return address of the routine RI2d is loaded. The routine RI2d introduces this second time lag by executing unnecessary instructions a certain number of times, for example.

### SECTION III: VARIANTS

### Section III.1: Variants of the Introduction of the Time Lag

There are many other methods of introducing a time lag during the execution of a secure function. All the methods presented below may be applied both to the introduction of the first time lag and to the introduction of the second time lag.

For example, a polymorphic code may be used to do this. Polymorphic codes are well known. For example, the reader may consult the following articles on this subject:
G. Agosta et al.: “A code morphing methodology to automate power analysis countermeasures”, DAC, 2012, pp. 77-82,
G. Agosta et al.: “The MEET approach: Securing cryptographic embedded software against side channel attacks”, IEEE TCAD, vol. 34, no. 8, pp. 1320-1333, 2015.
D. Couroussé et al.: “Runtime code polymorphism as a protection against side channel attacks,” WISTP, vol. 9895, 2016, pp. 136-152.

In summary, a polymorphic code of a secure function is capable of performing a given operation, but by executing, alternately, various variants of the executable code. Each of these variants produces the same result when it is executed by the microprocessor, but the code for each of these variants is different. For example, typically, to perform the given operation, each of the variants executes a different number of instructions and/or different instructions. The times taken by the microprocessor to execute each of these variants are therefore different from one another. Thus, choosing a variant that takes longer to execute than another variant introduces a time lag in the execution of the secure function. The executable code of each of these variants may be stored beforehand in a memory or be generated on the fly in a compilation phase prior to its execution. Conventionally, during the execution of the polymorphic code, the variant to be executed to perform the operation is randomly chosen. Instead of this, here the variant to be executed to perform the operation is chosen depending on the value of the first or the second delay. In other words, a variant whose execution time is equal to the first or to the second randomly chosen delay is chosen.

It is also possible to introduce a time lag into the execution of a secure function by decreasing the frequency of the clock that sets the rate of the operation of the microprocessor. On this subject, the reader may refer to the following article: T. Guneysu et al.: “Generic side-channel countermeasures for reconfigurable devices,” Cryptographic Hardware and Embedded Systems CHES 2011, Springer Berlin Heidelberg, 2011, pp. 33-48.

Another method for introducing a time lag into the execution of a secure function is to interrupt its execution for a preset time interval, either by preempting the execution of the secure function by triggering an interrupt, or by inserting into the code of the secure function calls to independent routines the execution time of which is variable. On this subject, the reader may consult the following article: J.-S. Coron et al.: “An efficient method for random delay generation in embedded software” Lecture Notes in Computer Science, vol. 5747 LNCS, pp. 156-170, 2009.

In the phase 46 of ordinary temporal desynchronization, the first time lag is not necessarily introduced in the same way depending on whether, in parallel, the phase 60 of reinforced temporal desynchronization is executed or not. For example, in phase 46, and in the absence of parallel execution of phase 60, the first time lag is introduced by modifying the frequency of the clock 6. When phases 46 and 60 are executed simultaneously, the first time lag may be introduced by triggering the execution of a routine RI1d. During the execution of this routine RI1d, the first delay is randomly chosen using the law Pₖ associated with the first instruction of the sequence Seqₖ. The second delay is randomly chosen using the law Sₖ. Next, the first and second delays thus chosen are added to each other to obtain a third delay. A time lag of a duration equal to the third delay is then introduced immediately before the time tsₖ. For example, in this case, this delay may be introduced by executing a loop of unnecessary instructions a sufficient number of times to delay the time tsₖ with respect to the time tsₖ₋₁ by a duration equal to the third time lag. In this case, since the first time lag is introduced by executing the routine RI1d, it does not need to be introduced using the module 18 and hence the module 18 may be temporarily deactivated.

The second time lag does not need to be introduced immediately before the first instruction of the sequence Seqₖ. In other words, the instruction I_{Zf,k} may be located one or more instructions before the first instruction of the sequence Seqₖ. The instruction I_{Zf,k} may even be located before the first instruction of the sequence Segₖ₋₁, or even anywhere between the instructions I₁ and the first instruction of the sequence Seqₖ.

The second time lag does not need to be introduced all at once. As a variant, the second time lag is divided into a plurality of sub-periods, the sum of which is equal to the duration of the second time lag. Next, each of these time-lag sub-periods is introduced during the execution of the secure function at different respective times located between the times tsₖ₋₁ and tsₖ. To do this, typically, the instructions I_{Zd,k} and I_{Zf,k} are separated from each other by a plurality of intermediate instructions and these time-lag sub-periods are each introduced before a respective intermediate instruction.

When the reinforced-temporal-desynchronization module is implemented in the form of a hardware or software module that operates independently of the secure function, this module comprises, for each sequence Segₖ, identifiers stored beforehand in its memory that allow it to identify particular instructions of the secure function that precede the sequence Seqₖ. These particular instructions identifiable by the module 20 correspond to the instructions I_{Zd,k} and I_{Zf,k}. For example, the identifiers used are the addresses of the instructions I_{Zd,k} and I_{Zf,k}. In this case, the module 20 continuously compares the address of the instruction loaded by the microprocessor 10 with the previously stored addresses of the instructions I_{Zd,k}. When the module 20 determines that the address of the instruction loaded by the microprocessor 10 corresponds to one of the previously stored addresses of the instructions I_{Zd,k}, then it executes the operations 62 and 64. In the case where the address of the instruction loaded by the microprocessor 10 corresponds to the previously stored address of an instruction I_{Zf,k}, then the module 20 interrupts the execution of phase 60. If the introduction of the second time lag has not yet ended when the instruction I_{zf,k} is loaded or executed, then the second time lag is introduced at that time, all at once in step 64.

### Section III.2: Variants of the Laws Sₖ and Pₘ

As a variant, the distances between two successive values of the group G_{2,k} are not all the same. In other words, the n_{2,k} values of the group G_{2,k} do not need to be uniformly distributed. For example, in the case where n_{2,k}=3, the group G_{2,k} contains the following three values 0, i.dₑ and 4.i.dₑ instead of the three values 0, i.dₑ and 2.i.dₑ as described in the preceding embodiments.

As a variant, conditions (3) and (3′) are not met. In this case, the distance between any two successive values of the group G_{2,k} is not equal to i.dₑ, but strictly larger than i.dₑ. For example, this distance is larger than or equal to 1.1.i.dₑ or 1.5.i.dₑ or 2.i.dₑ.

In another variant, the group G_{2,k} does not contain the value 0. For example, the group G_{2,k} contains only the values i.dₑ and 2.i.dₑ.

The T sequences Seqₖ that meet condition (4) or (4′) are not necessarily consecutive sequences Seqₖ but may be arbitrarily chosen from the set of sequences Seqₖ.

Condition (4) or (4′) need not be met. In this case, the group G_{2,k} is generally different from the group G_{2,k+1}. Specifically, the maximum SPmaxₖ or SSmaxₖ varies as a function of the value of the index k.

More generally, the laws Sₖ and Sₖ₊₁ may differ from each other in one or more of the following features:
the number n_{2,k} of values in the group G_{2,k},
the values xₗ contained in the group G_{2,k}, or
the probabilities of occurrence Sₖ[xₗ] associated with the values xₗ of the group G_{2,k}.

Even when condition (4) or (4′) is met by the values of the groups G_{2,k} and G_{2,k+1}, the laws Sₖ and Sₖ₊₁ are not necessarily identical. For example, these laws Sₖ and Sₖ₊₁ may differ from each other in the probabilities associated with each of the values xₗ of the group G_{2,k}.

The same sequence Seqₖ may be associated with a plurality of different laws Sₖ here denoted S_{k,1}, S_{k,2}, S_{k,3} and so on. The laws S_{k,1}, S_{k,2}, S_{k,3} all meet condition (1). Here, the laws S_{k,1}, S_{k,2} and S_{k,3} are for example obtained for different values of the number p, denoted p₁, p₂ and p₃, with, for example, p₁>1.3, p₂>p₁ and p₃>p₂. In other words, the value obtained for SEmaxₖ is higher when the law S_{k,1} is used than when the law S_{k,2} is used. Likewise, the maximum SEmaxₖ is higher when the law S_{k,2} is used than when the law S_{k,3} is used. Next, during the execution of the secure function, the module 20 selects, from among the various possible laws S_{k,1}, S_{k,2}, S_{k,3}, the law to be used to randomly choose the value of the second delay. This selection is preferably made depending on the context in which the secure function is executed. For example, the module 20 automatically selects the law Sₖ to be used depending on a required security level that was transmitted to it beforehand. The required security level may be determined by the computer itself. Thus if the computer detects or determines that it is probable that it is currently being subjected to an attack, a side-channel attack for example, then the computer 4 increases the security level, this leading to a law Sₖ that decreases the maximum SEmaxₖ more being selected. The security level may also be selected depending on the nature of the processing operations currently being executed by the computer 4.

In the embodiments described above, the distribution SPₖ is used instead of the distribution SSₖ to construct the law Sₖ. In other embodiments, the statistical distribution SSₖ is constructed and then used in turn to construct the law Sₖ. In this case, it is possible to construct groups G_{2,k} of values that meet condition (1) without meeting condition (2). Contrary to the statistical distribution SPₖ, the statistical distribution SSₖ takes into account both the first and the second time lags already introduced before the execution of the sequence Seqₖ. Thus, to construct the statistical distribution SSₖ, it is necessary to know the statistical distribution SSₖ₋₁ and the law Sₖ₋₁. Therefore, it is possible to construct the statistical distribution SSₖ using an iterative process. For example, from the time t=0 to the time t=kₘₐₓ, where kₘₐₓ is the highest value of the index k, the following operations are reiterated:

1) constructing the statistical distribution SSₜ₊₁ on the basis of the statistical distribution SSₜ, of the law Sₜ and of the laws Pₘ used to introduce the first time lags between the time tsₜ₋₁ and the time tsₜ, then
2) constructing the law Sₜ₊₁ on the basis of the statistical distribution SSₜ₊₁ and of its maximum SSmaxₜ₊₁.

The statistical distribution SS₁ is equal to the statistical distribution SP_{Zf,1} because, before the time t_{Zf,1}, no second time lag other than the one chosen according to the law S₁ has yet been introduced.

Many variants of the Pₘ law are possible. Similarly to what was described with respect to the law Sₖ, the law Pₘ used to choose the value of the first delay is not necessarily always the same for all the instructions Iₘ. For example, the laws Pₘ and Pₘ₊₁ may differ from each other in one or more of the following features:
the number n_{1,m} of values in the group G_{1,m},
the values contained in the group G_{1,m},
the probabilities of occurrence of each of the values of the group G_{1,m}.

The law Pₘ may also associate, with one or more values of the group G_{1,m}, a zero probability of occurrence. For example, the law Pₘ may associate a zero value of occurrence with the zero value of the first delay. Thus, each time a new value of the first delay is chosen, this new value is systematically different from the zero value.

### Section III.3: Variants of the Computing System

Many other embodiments of the system 2 are possible. For example, the module 20 is not necessarily a software module executed by the same microprocessor as that which executes the secure function. Thus, as a variant, the module 20 is a software module executed by a security microprocessor capable of introducing the second time lags during the execution of the secure function by the microprocessor 10. The module 20 may also take the form of a hardware module able to execute phase 60. When the modules 18 and 20 are modules that are independent of the microprocessor 10, these modules may be implemented on the same security microprocessor or in the same hardware module independent of the microprocessor 10.

The microprocessor 10 that executes the secure function is not necessarily a generic microprocessor equipped with an arithmetic logic unit able to execute a program stored in an external memory. For example, as a variant, the microprocessor is a specific microprocessor only capable of executing the secure function. For example, such a specific microprocessor is a hardware module dedicated to the execution of this specific function and that cannot be programmed to execute new functions other than those provided for during its design. For example, it may be a hardware module designed to execute the AES secure function.

### Section III.4: Variants of the Temporal Desynchronization Method

The initialization phase 40 may be carried out by the computer 4 itself. In this case, during the initialization phase, the microprocessor 10 executes the secure function a plurality of times and, during each of these executions, only the phase 46 of ordinary temporal desynchronization is implemented. During this initialization phase, phase 60 of reinforced temporal desynchronization is not executed. Typically, in this case, during this initialization phase, the secret information processed by the secure function is replaced by decoys. For example, the encryption keys are replaced by randomly drawn encryption keys. Thus, this secret information cannot be leaked during the initialization phase by the repeated executions of the secure function. During this initialization phase, for each sequence Seqₖ, the module 20 notes the time tsₖ at which the execution of this sequence begins. As described above, on the basis of these various measurements, the module 20 constructs the statistical distribution SPₖ and therefore obtains the value of the maximum SPmaxₖ. Next, the module 20 chooses the number n_{2,k}, for example as described above. In another embodiment, the number n_{2,k} may be randomly chosen from a limited group of integers. The law Sₖ[xₗ] is systematically chosen to be equal to 1/n_{2,k}. From this moment, the module 20 automatically determines a set of values x₁ that meets condition (1) and in addition, optionally, condition (2), (3′) and/or (4′). To do this, it uses the distribution SPₖ that it has determined automatically. At this stage, the law Sₖ has been automatically constructed and it is then stored in the memory 12 associated with the sequence Seqₖ. This memory 12 comprises, beforehand, the identifiers of the instructions I_{Zd,k} and I_{Zf,k}. For example, these instructions are, as in the embodiments previously described, a call and return instruction of the routine RI2d, respectively. Once the law Sₖ has been determined for each of the sequences Seqₖ, then the initialization phase stops and the computer 4 then proceeds to the actual phase of execution of the secure function. This execution phase is for example identical to phase 42 described above.

The module 20 may also execute the initialization phase 40 at the same time as the execution phase 42. For example, as in the embodiment of the above paragraph, the module 20 constructs the statistical distribution SPₖ just before the execution of the sequence Seqₖ on the basis of knowledge of the laws Pₘ and of the order number m of the first instruction of the sequence Seqₖ. On the basis of this determined statistical distribution SPₖ, the module 20 constructs the law Sₖ as described above. In this case, the law Sₖ is constructed between the times tsₖ₋₁ and tsₖ.

Advantageously, in the initialization phase 40, the microprocessor also identifies the instruction I_{f} from which the insertion of the second delays becomes unnecessary to meet the condition SEmaxₖ<S_{1,k} and may therefore be systematically inhibited. For example, to do this the microprocessor proceeds as described in the main embodiment. In particular, the microprocessor identifies the last instruction Iₐ, and therefore the time tₐ, for which the following condition is met: SPmaxₐ>S_{1,k}. Since, in order to do this, the statistical distribution SPₘ must be determined for various times tiₘ, this determination is carried out either during the execution of an initialization phase 40 that precedes the execution of phase 42 or during an initialization phase 40 executed at the same time as the phase 42. These two alternatives are for example implemented as described in the two preceding paragraphs.

In one simplified embodiment, the instructions I_{Zd,k} and I_{Zf,k} are automatically introduced into the code of the secure function by the computer 4 in phase 40. For example, the computer 4 distributes randomly or, on the contrary, uniformly, these instructions I_{Zd,k} and I_{Zf,k} throughout the code of the secure function. In this case, the sequences Seqₖ do not necessarily correspond to a sequence of critical instructions.

In another variant, phase 60 is executed in response to a command received by the computer 4. In this case, until this command is received, even if the microprocessor 10 loads or executes an instruction I_{Zd,k}, phase 60 is not executed. In contrast, after receipt of this command, as soon as the microprocessor 10 loads or executes an instruction I_{Zd,k}, phase 60 is executed. For example, this command is sent and received by the computer 4 as soon as an attempt at attack is detected. In another variant, this command comprises the law Sₖ and the group G_{2,k} to be used to introduce, immediately in response, a second time lag. In this case, phase 60 may be triggered at any time and without waiting for an instruction I_{Zd,k} to be loaded or executed by the microprocessor 10. In this last variant, the instructions I_{zd,k} and I_{Zf,k} may be omitted.

Similarly, phase 60 may be interrupted in response to a command received by the computer 4.

In another embodiment, in response to the instruction I_{Zd,k} being loaded or executed, before the execution of phase 60 is triggered, the module 20 determines, by computation, the maximum SPmax_{Zd,k} of the statistical distribution SP_{Zd,k}. Next, it compares this computed maximum SPmax_{Zd,k} with a high threshold Sₕ stored beforehand. If the computed maximum SPmax_{Zd,k} is higher than this threshold Sₕ, then the module 20 triggers the execution of phase 60. In the contrary case, the module 20 inhibits the execution of phase 60. This allows the times at which phase 60 is triggered to be automatically adapted to various secure functions executable by the same microprocessor 10.

As a variant, phase 46 is not executed throughout the duration of the execution of the secure function. For example, phase 46 may be interrupted when the instructions being executed are not critical. Subsequently, the execution of phase 46 may also be restarted if necessary. Optionally, phase 60 may continue to be executed during the period of time in which phase 46 is interrupted. It is even possible to execute phase 60 only during the period of time in which phase 46 is interrupted.

Steps 62 and 64 may be executed a plurality of times for the same sequence Seqₖ. For example, in the embodiment described with reference to FIG. 7, this allows, in each iteration of steps 62 and 64 and before the execution of the sequence Seqₖ, a second delay to be introduced that divides by two the maximum SEmaxₖ obtained after the preceding iteration of steps 62 and 64 for this same sequence Seqₖ.

Certain side-channel attacks are carried out by taking as reference time the time at which the execution of the secure function ends. To make these attacks difficult, it is also necessary to minimize the maximum SEmaxₖ in the case where the reference time t_{ref} is equal to the time t_{der} and the direction D_{ref} points from the instruction I_{Der} to the instruction I_{Deb}. In this case, the statistical distributions SSₖ or SPₖ are different from those constructed when the reference time t_{ref} is equal to the time t_{deb}. More generally, if it is suspected that a time at which a particular instruction of the secure function is executed may be used as a reference time to implement a side-channel attack, then the methods described here may be implemented choosing as time t_{ref} this time at which this particular instruction is executed. The time t_{ref} may therefore be located between the times t_{deb} and t_{der}. In particular, to protect the execution of the secure function, from various side-channel attacks using various reference times, a plurality of phases of reinforced temporal desynchronization similar to phase 60 may be executed in parallel. These various phases of reinforced temporal desynchronization then differ from one another only in the time t_{ref} chosen as the reference time. In particular, it is useful to execute, in parallel with phase 60, an additional phase of reinforced temporal desynchronization for which the reference time t_{ref} has been chosen to be equal to t_{der}. Specifically, this then allows the instructions located at the start of the secure function to be protected, as well as those located at the end of the secure function.

### Section III.5: Other Variants

The number of instructions contained in the sequence Seqₖ is for example equal to one.

As a variant, the group of secure-function instructions before each of which steps 48 and 50 are executed does not contain all the instructions of the secure function, but only a small number of these instructions Iₘ. For example, this group contains only one instruction in two of the secure function.

### SECTION IV: ADVANTAGES OF THE DESCRIBED EMBODIMENTS

Introducing a second time lag in addition to the first time lag allows the maximum SEmaxₖ to be decreased and therefore side-channel attacks to be made more difficult. In addition, this decrease in the maximum SEmaxₖ is obtained without it being necessary to modify the law Pₘ. Therefore, this method may be implemented in cases where it is not possible or not desirable to modify the laws Pₘ used to randomly choose the first delays. The method described here may therefore be implemented in a higher number of cases.

The fact that the law Sₖ is equiprobable or practically equiprobable allows, for a group G_{2,k} of given values, the maximum SEmaxₖ to be minimized and therefore side-channel attacks to be made even more difficult.

Choosing each value xₗ between 0.9.l.i.dₑ and 1.1.l.i.dₑ, where i is the lowest integer that meets condition (3) or (3′), allows, for a preset number n_{2,k} of values of the group G_{2,k}, the execution time of the secure function to be minimized.

Choosing n_{2,k}=2 allows the execution time of the secure function to be minimized.

The fact that the values xₗ of the group G_{2,k} in addition meet condition (4) or (4′) allows the same group G_{2,k} of values to be used to decrease the maximum SEmaxₖ of a plurality of sequences Sₖ to S_{k+T-1}.

Inhibiting the execution of phase 60 well before the end of the execution of the secure function allows the execution time of this secure function to be shortened.

Inhibiting the execution of phase 60 after the execution of the instruction I_{f} allows the execution time of the secure function to be further decreased.

Determining SPmaxₖ and triggering phase 60 only if the maximum SPmaxₖ crosses a preset threshold allows the time at which phase 60 is triggered to be automatically adapted to various secure functions executable by the same microprocessor 10.

1. A method allowing a function secured by temporal desynchronization to be executed by a microprocessor, the method comprising:
execution, by the microprocessor, of instructions of the function one after another, and in parallel, the execution of a first phase of desynchronization, called a “phase of ordinary temporal desynchronization”, the phase of ordinary temporal desynchronization comprising, before the execution by the microprocessor of each instruction Iₘ of a group of instructions of the function, carrying out the following steps:
(1) making a random choice of a value of a first delay from a group G_{1,m} of n_{1,m} possible values of this first delay, where n_{1,m} is an integer higher than or equal to two, each of the n_{1,m} possible values being an integer multiple of an elementary duration dₑ, the random choice being made according to a first probability law Pₘ that associates a probability of occurrence with each of the possible values of the group G_{1,m}, and
(2) introducing a first time lag equal to the first delay before the execution of the instruction so that, with respect to the time at which the execution of the function begins, the time at which the execution of the instruction begins varies randomly on each execution of the function,
wherein, during the execution, by the microprocessor, of the instructions of the function, the method further comprises the execution of a second phase of temporal desynchronization, called a “phase of reinforced desynchronization”, of a sequence Seqₖ of instructions of the function, the phase of reinforced temporal desynchronization of the sequence Seqₖ comprising carrying out the following steps:
(3) making a random choice of a value of a second delay from a group G_{2,k} of n_{2,k} possible values of this second delay, where n_{2,k} is an integer higher than or equal to two, the random choice being made according to a second probability law Sₖ that associates a probability of occurrence with each of the n_{2,k} possible values of the group G_{2,k}, the values of the group G_{2,k} meeting the following condition:
$$∀ j ∈ lN , {\sum }_{l = 0}^{{n}_{2 , k} - 1} {S}_{k} [ {x}_{l} ] {SS}_{k} ( j . {d}_{e} + {x}_{l} ) < \frac{{SSmax}_{k}}{P}$$
wherein
the index k is an order number such that the index k−1 is equal to the number of sequences of instructions to be protected to be executed by the microprocessor between times t_{ref} and tsₖ,
tsₖ is the time at which the microprocessor executes the first instruction of the sequence Seqₖ,
t_{ref} is a reference time at which the microprocessor executes a particular instruction I_{ref} of the function, this particular instruction always being a same on each execution of the function,
x₀ to xₙ_{^{2,k}}₋₁ are the n_{2,k} values of the groups G_{2,k},
Sₖ [xₗ] is the probability of occurrence associated with the value xₗ by the law Sₖ,
SSₖ is the statistical distribution of the possible values of the sum of the time lags that have already been introduced between the times t_{ref} and tsₖ, the statistical distribution associating a probability of occurrence with each of the possible values of the sum of the time lags that have already been introduced between the times t_{ref} and tsₖ,
SSmaxₖ is the highest value of the statistical distribution SSₖ,
p is a real number higher than 1.3, and
the symbol “.” designates the operation of multiplication, and
(4) introducing a second time lag equal to the second delay between the times t_{ref} and tsₖ.

2. The method as claimed in claim 1, wherein, whatever the index l, the probability of occurrence Sₖ[xₗ] is comprised between 0.9/n_{2,k} and 1.1/n_{2,k}.

3. The method of claim 1, wherein, whatever the index l, the value xₗ of the group G_{2,k} is comprised between 0.9.l.i.dₑ and 1.1.l.i.dₑ, wherein i is the lowest integer for which one of the following conditions is met:
$$\begin{matrix}∀ j ∈ lN , {\sum }_{l = 0}^{{n}_{2 , k} - 1} {S}_{k} [ l . i . {d}_{e} ] . {SS}_{k} ( j . {d}_{e} + l . i . {d}_{e} ) < \frac{{SSmax}_{k}}{P} \\ or \\ ∀ j ∈ lN , {\sum }_{l = 0}^{{n}_{2 , k} - 1} {S}_{k} [ l . i . {d}_{e} ] . {SP}_{k} ( j . {d}_{e} + l . i . {d}_{e} ) < \frac{{SPmax}_{k}}{P}\end{matrix}$$
wherein
SPₖ is the statistical distribution of the possible values of the sum of the first time lags that have already been introduced between the times t_{ref} and tsₖ, this statistical distribution associating a probability of occurrence with each of the possible values of the sum of the first time lags that have already been introduced between the times t_{ref} and tsₖ, and
SPmaxₖ is the highest value of the statistical distribution SPₖ.

4. The method as claimed in claim 1, wherein the number n_{2,k} is equal to two.

5. The method as claimed in claim 1, wherein:
the values of group G_{2,k} in addition meet the following condition:
$$∀ t ∈ [ k ; k + T - 1 ] , ∀ j ∈ lN , {\sum }_{l = 0}^{{n}_{2 , k} - 1} {S}_{k} [ {x}_{l} ] {SS}_{k} ( j . {d}_{e} + {x}_{l} ) < \frac{{SSmax}_{k}}{P}$$
wherein T is an integer higher than or equal to two,
the execution, by the microprocessor, of the instructions of the function one after another comprises the execution of a plurality of sequences Seqₖ to Seq_{k+T-1} of instructions to be protected, and
the execution of the phase of reinforced temporal desynchronization for each of the sequences Seqₖ to Seq_{k+T-1}, step 3)]], which is executed for each of the sequences Seqₖ to Seq_{k+T-1}, being carried out using, each time, the same group G_{2,k} of n_{2,k} values.

6. The method as claimed in claim 1, wherein between the instruction I_{ref} and an instruction I_{f} located between the first and last instructions of the function:
the phase of ordinary temporal desynchronization is executed, and
the phase of reinforced temporal desynchronization is executed for each sequence Seqₖ located between these instructions I_{ref} and I_{f}, and
from the instruction I_{f}, the execution of the phase of reinforced temporal desynchronization is systematically inhibited while the execution of the phase of ordinary temporal desynchronization is continued.

7. The method as claimed in claim 6, wherein the execution of the phase of reinforced temporal desynchronization is systematically inhibited from a time t_{f} comprised between times tₐ and t_{b}, the time t_{f} being the time at which the instruction I_{f} is executed and the times tₐ and t_{b} being the times of introduction of the a-th first time lag and of the b-th first time lag from the time t_{ref} respectively, where the time tₐ is the last time, since the time t_{ref}, for which the following condition is met: SPmaxₐ>S₁, wherein
SPmaxₐ is the highest value of the statistical distribution SPₐ, where the statistical distribution SP is the statistical distribution of the possible values of the sum of the first time lags that have already been introduced between the times t_{ref} and tₐ, the statistical distribution associating a probability of occurrence with each of the possible values of the sum of the first time lags that have already been introduced between the times t_{ref} and tₐ,
“b” is an integer number higher than “a” and lower than “a+100”, and
S₁ is a positive threshold lower than 0.2.

8. The method as claimed in claim 7, wherein the microprocessor determines, for various times tiₘ at which a first time lag is introduced, the distribution SPₘ of the sum of the first time lags between the time t_{ref} and the time tiₘ until the identification of the time tiₘ that is the last time, since the time t_{ref}, for which the following condition is met: SPmaxₘ>S₁, the time tₐ then being set equal to this identified time tiₘ.

9. The method as claimed in claim 1, wherein, during the execution of the function by the microprocessor, in response to loading or to execution of an instruction I_{Zd,k} at the start of a zone of introduction of a second time lag, the temporal desynchronization module triggers the execution of the phase of reinforced temporal desynchronization.

10. The method as claimed in claim 1, wherein the number p is higher than 1.5 or 1.8.

11. The method as claimed in claim 1, wherein the phase of ordinary temporal desynchronization is executed repeatedly between the times t_{ref} and tsₖ.

12. A non-transitory data-storage medium that is readable by an electronic computer, wherein the medium comprises instructions for executing a method as claimed in claim 1, when the instructions are executed by the electronic computer.

13. An electronic computer, comprising:
a microprocessor configured to execute instructions of a function one after another,
an ordinary-temporal-desynchronization module configured to execute a phase of ordinary temporal desynchronization, the phase of ordinary temporal desynchronization comprising, before the execution by the microprocessor of each instruction Iₘ of a group of instructions of the function, carrying out the following steps:
(1) making a random choice of a value of a first delay from a group G_{1,m} of n_{1,m} possible values of this first delay, where n_{1,m} is an integer higher than or equal to two, each of the n_{1,m} possible values being an integer multiple of an elementary duration dₑ, the random choice being made according to a first probability law Pₘ that associates a probability of occurrence with each of the possible values of the group G_{1,m}, and
(2) introducing a first time lag equal to the first delay before the execution of the instruction so that, with respect to the time at which the execution of the function begins, the time at which the execution of this instruction begins varies randomly on each execution of the function,
wherein the electronic computer further comprises a reinforced-temporal-desynchronization module configured to execute a phase of reinforced temporal desynchronization of a sequence Seqₖ of instructions of the function, during the execution, by the microprocessor, of the instructions of the function, the phase of reinforced temporal desynchronization of the sequence Seqₖ comprising carrying out the following steps:
(3) making a random choice of a value of a second delay from a group G_{2,k} of n_{2,k} possible values of this second delay, where n_{2,k} is an integer higher than or equal to two, the random choice being made according to a second probability law Sₖ that associates a probability of occurrence with each of the n_{2,k} possible values of the group G₂ₖ, the values of the group G_{2,k} meeting the following condition:
$$∀ j ∈ lN , {\sum }_{l = 0}^{{n}_{2 , k} - 1} {S}_{k} [ {x}_{l} ] {SS}_{k} ( j . {d}_{e} + {x}_{l} ) < \frac{{SSmax}_{k}}{P}$$
wherein
the index k is an order number such that the index k−1 is equal to the number of sequences of instructions to be protected to be executed by the microprocessor between times t_{ref} and tsₖ,
tsₖ is the time at which the microprocessor executes the first instruction of the sequence Seqₖ,
t_{ref} is a reference time at which the microprocessor executes a particular instruction of the function, the particular instruction always being a same on each execution of the function,
x₀ to xₙ_{^{2,k}}₋₁ are the n_{2,k} values of the groups G_{2,k},
Sₖ [xₗ] is the probability of occurrence associated with the value xₗ by the law Sₖ,
SSₖ is the statistical distribution of the possible values of the sum of the time lags that have already been introduced between the times t_{ref} and tsₖ, the statistical distribution associating a probability of occurrence with each of the possible values of the sum of the time lags that have already been introduced between the times t_{ref} and tsₖ,
SSmaxₖ is the highest value of the statistical distribution SSₖ,
p is a real number higher than 1.3, and
the symbol “.” designates the operation of multiplication, and
(4) introducing a second time lag equal to the second delay between the times t_{ref} and tsₖ.
